(19) United States
(12) Patent Application Publication
(10) Pub. No.: US 2007/0092763 A1
(43) Pub. Date: Apr. 26, 2007

(54) Fuel cell system

(75) Inventor: Masutaka Ouchi, Kusatsu-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/510,813

(22) Filed: Aug. 28, 2006

(30) Foreign Application Priority Data
Aug. 31, 2005 (JP) 2005-252452(PAT.)

(51) Int. Cl. H01M 16/00; H01M 8/04

(52) U.S. Cl. 429/9; 429/23

(57) ABSTRACT

There is provided a fuel cell system including a fuel cell, a secondary battery having an open circuit voltage lower than an open circuit voltage of the fuel cell, a voltage detector for detecting a voltage of the fuel cell, a switch for connecting the secondary battery in parallel to the fuel cell, and a controller for controlling the switch according to a detection voltage detected by the voltage detector. According to the fuel cell system of the prevent invention, power loss and secondary battery degradation caused by overcharging can be suppressed and at the same time, its configuration can be simplified.

### BACKGROUND OF THE INVENTION

1. Field of the Invention

The present invention relates to a hybrid type fuel cell system using a combination of fuel cell and secondary battery, and a fuel cell system applicable to a hybrid type fuel cell system.

2. Description of the Related Art

In a hybrid type fuel cell system with a fuel cell and secondary battery, at the time of low load, the fuel cell excellent in energy density drives an external load and at the same time, charges the secondary battery; at the time of high load, the secondary battery excellent in output performance discharges to bear part of the load. Thus, such hybrid type fuel cell system is attracting attention as an efficient power generation device.

In Japanese Patent Application Laid-Open No. H11-252711, as this kind of hybrid type fuel cell system, there is disclosed a fuel cell and secondary battery connected in parallel. In this hybrid type fuel cell system, as the load being an output object increases, the current share ratio of the fuel cell decreases and the current share ratio of the secondary battery relatively increases. Consequently, any control unit for controlling the current share ratio between the fuel cell and secondary battery needs not to be provided, allowing downsizing of the hybrid type fuel cell system.

Also, in Japanese Patent Application Laid-Open No. 2004-071260, there is disclosed a secondary battery connected via a charge/discharge controller to a fuel cell, the secondary battery having a lower output voltage than that of the fuel cell at the time of low load. In this hybrid type fuel cell system, charging and discharging of the secondary battery can be properly controlled according to the power generation state of the fuel cell.

Meanwhile, as a technique of feeding a proper output to an external load, there is disclosed in Japanese Patent Application Laid-Open No. H07-153474 a technique of adjusting a voltage difference between a fuel cell and secondary battery by use of a power adjustor such as a DC/DC converter and performing outputting.

Also, in Japanese Patent Application Laid-Open No. H11-339833, there is disclosed a hybrid type fuel cell system which, in order to obtain a proper output and a proper charging state of secondary battery, the number of secondary batteries connected to a fuel cell is sequentially changed to perform power generation.

However, in the hybrid type fuel cell systems described in Japanese Patent Application Laid-Open No. H11-252711 and Japanese Patent Application Laid-Open No. 2004-071260, the voltage of fuel cell changes according to a variation in load, and the secondary battery may thus be charged at a higher voltage than required. Accordingly, the secondary battery may be overcharged, causing its degradation.

Also, in the hybrid type fuel cell system described in Japanese Patent Application Laid-Open No. H07-153474, the power adjustor is required, thus raising the cost. Further, in the power adjustor, power conversion loss occurs, resulting in a problem of losing part of power.

Also, in the hybrid type fuel cell system described in Japanese Patent Application Laid-Open No. H11-339833, each secondary battery must be individually connected or disconnected to the fuel cell, resulting in a problem of complicating the configuration of the hybrid type fuel cell system.

The above described power loss and complicated configuration has impeded implementation of downsizing and high efficiency.

### SUMMARY OF THE INVENTION

The present invention is directed to a hybrid type fuel cell system capable of suppressing power loss and secondary battery degradation caused by overcharging and at the same time, having a simplified configuration, and to a fuel cell system applicable to a hybrid type fuel cell system.

The present invention is directed to a hybrid type fuel cell system characterized by including: a fuel cell; a secondary battery having an open circuit voltage lower than an open circuit voltage of the fuel cell; a voltage detector for detecting a voltage of the fuel cell; a switch for connecting the secondary battery in parallel to the fuel cell; and a controller for controlling the switch according to a detection voltage detected by the voltage detector.

Also, the hybrid type fuel cell system according to the present invention is characterized in that, at the time of initiating power supplying to the outside, the switch is changed to a connection state, and when the detection voltage is equal to or more than a first set value, the switch is changed to a disconnection state, and when the detection voltage is equal to or less than a second set value which is lower than the set value, the switch is changed to a connection state.

Another present invention is directed to a fuel cell system characterized by including: a fuel cell; a secondary battery connection terminal for connecting in parallel a secondary battery having an open circuit voltage lower than an open circuit voltage of the fuel cell; a voltage detector for detecting a voltage of the fuel cell; a switch for connecting the secondary battery connection terminal in parallel to the fuel cell; and a controller for controlling the switch according to a detection voltage detected by the voltage detector.

The present invention allows provision of a hybrid type fuel cell system capable of suppressing power loss and secondary battery degradation caused by overcharging and at the same time, capable of having a simplified configuration and having excellence in downsizing and low cost.

Further features of the present invention will become apparent from the following description of exemplary embodiments with reference to the attached drawings.

### BRIEF DESCRIPTION OF THE DRAWINGS

FIG. 1 is a configuration diagram showing a hybrid type fuel cell system according to the present invention.

FIG. 2 is a view showing a control flow in the hybrid type fuel cell system according to the present invention.

FIG. 3 is a view showing a current-voltage curve at the time of high load in the hybrid type fuel cell system according to the present invention.

FIG. 4 is a view showing a current-voltage curve at the time of low load in the hybrid type fuel cell system according to the present invention.

FIG. 5 is a view showing switching from low load to high load in the hybrid type fuel cell system according to the present invention.

FIG. 6 is a configuration diagram showing another example of the hybrid type fuel cell system according to the present invention.

FIG. 7 is a block diagram for explaining an exemplary controller of the hybrid type fuel cell system according to the present invention.

### DESCRIPTION OF THE EMBODIMENTS

The present invention will be described below in detail.

A fuel cell system according to the present invention is characterized by including: a fuel cell; a secondary battery having an open circuit voltage lower than an open circuit voltage of the fuel cell; a voltage detector for detecting a voltage of the fuel cell; a switch for connecting the secondary battery in parallel to the fuel cell; and a controller for controlling the switch according to a detection voltage detected by the voltage detector.

Another fuel cell system according to the present invention is characterized by including: a fuel cell; a secondary battery connection terminal for connecting in parallel a secondary battery having an open circuit voltage lower than an open circuit voltage of the fuel cell; a voltage detector for detecting a voltage of the fuel cell; a switch for connecting the secondary battery connection terminal in parallel to the fuel cell; and a controller for controlling the switch according to a detection voltage detected by the voltage detector.

According to the present invention, when the load is low and the voltage of fuel cell is high and at the same time, charging quantity of secondary battery is smaller than when fully charged, the fuel cell and secondary battery are connected in parallel to each other and the secondary battery is charged according to a difference between the voltage of fuel cell and the open circuit voltage of secondary battery. When the load increases and the voltage of fuel cell lowers and falls below the open circuit voltage of secondary battery, the direction of current flowing in the secondary battery is inverted to initiate discharging of the secondary battery.

Since the voltage of fuel cell is detected, the state of load can be detected and at the same time, the voltage of secondary battery can be found, allowing management of the charging state thereof. When the load is low and the voltage of fuel cell is high and at the same time, charging quantity of secondary battery reaches a scheduled value, the connection between the fuel cell and secondary battery is cut off by the switch controlled by the voltage detector to stop charging. When the load increases again and the voltage of fuel cell lowers to a predetermined value or less, the fuel cell and the secondary battery group are connected in parallel to each other, thereby initiating discharging of the secondary battery.

Also, since the secondary battery is charged by a difference between the voltage of fuel cell and the open circuit voltage of secondary battery, as charging quantity of secondary battery increases and the difference between the voltage of fuel cell and the open circuit voltage of secondary battery decreases, charging current of secondary battery also decreases. Consequently, charging proceeds according to charging current dependent on charging quantity of secondary battery as appropriate, and charging can thus be efficiently performed.

As described above, according to the present invention, switching of secondary battery between charging, discharging and pause can be executed only by performing, based on the voltage of fuel cell, switching between the state of connecting in parallel the fuel cell and secondary battery and the state of non-connection. Accordingly, it is possible to provide the hybrid type fuel cell system having a simple configuration.

Further, according to the present invention, at the time of initiating power supplying to an external load, the switch connects the fuel cell and secondary battery, whereby a sequence of operations described above can be initiated in which, according to the magnitude of load, switching between charging and discharging of secondary battery is performed.

Also, when charging quantity of secondary battery increases and the voltage of fuel cell increases to a first set value, the switch cuts off the connection between the fuel cell and the secondary battery to thereby stop charging of secondary battery, making it possible to surely prevent degradation of secondary battery caused by overcharging.

Also, when the voltage of fuel cell lowers to a second set value which is lower than the set value, the switch connects in parallel the fuel cell and the secondary battery again, whereby the secondary battery discharges and can bear part of the load.

As described above, according to the present invention, at the time of initiating power supplying to an external load, the fuel cell and secondary battery are connected in parallel to each other and later, based on the two set values with respect to the voltage of fuel cell, switching control is performed between the state of connecting the fuel cell and secondary battery and the state of non-connection. According to the present invention, such control alone allows switching of secondary battery between charging, discharging and pause. Consequently, it is possible to provide the hybrid type fuel cell system which can prevent overcharging of secondary batter and has a very simple configuration.

Also, according to another present invention, switching between charging, discharging and pause of the secondary battery connected via the secondary battery connection terminal to the fuel cell system can be executed only by performing, based on the voltage of fuel cell, switching between the state of connecting in parallel the fuel cell and secondary battery connection terminal and the state of non-connection. Accordingly, it is possible to provide the hybrid type fuel cell system having a simple configuration.

The present invention will be described below more in detail with reference to illustrative examples, but the present invention is not limited to these illustrative examples.

### Embodiment 1

An embodiment of a hybrid type fuel cell system according to the present invention will be described with reference to the drawings.

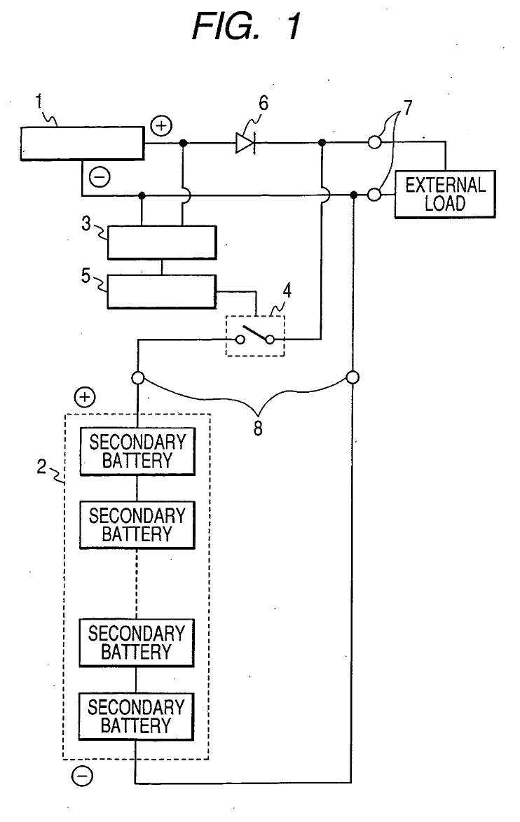

FIG. 1 is a configuration diagram showing a hybrid type fuel cell system according to the present embodiment. The hybrid type fuel cell system of the present embodiment includes: a fuel cell 1; a secondary battery series body 2 constituted of secondary batteries connected in series; a voltage detector 3 for detecting a voltage of the fuel cell 1; a switch 4 performing switching between the state of connecting the secondary battery series body 2 in parallel to the fuel cell 1 and the state of non-connection; and a controller 5 for controlling the switch 4 according to the detection voltage. The open circuit voltage of the secondary battery series body 2 is set lower than the open circuit voltage of the fuel cell 1. Also, on a circuit connecting the fuel cell 1 and the secondary battery series body 2, there is arranged a diode 6 for preventing an inverse current to the fuel cell 1. Also, an external load is connected to an external load connection terminal 7, and the secondary battery series body 2 is connected to a secondary battery connection terminal 8.

In the hybrid type fuel cell system of the present embodiment, at the time of initiating power supplying to an external load, the switch 4 is changed to the state of connecting in parallel the fuel cell 1 and the secondary battery series body 2. When,the detection voltage obtained by the voltage detector 3 is equal to or more than set value V₁ which is higher than the open circuit voltage of the secondary battery series body 2, the switch 4 is changed to the state of not connecting in parallel the fuel cell 1 and the secondary battery series body 2. Also, when the detection voltage is equal to or less than set value V₂ which is lower than set value V₁, the controller 5 controls the switch 4 so that the fuel cell 1 and the secondary battery series body 2 are connected in parallel to cause the secondary battery series body 2 to discharge. Since the fuel cell 1 and the secondary battery series body 2 are connected in parallel, as long as the connection is maintained, the voltage of the secondary battery series body 2 can be found by detecting the voltage of the fuel cell 1, allowing management of the charging state thereof.

The open circuit voltage of the secondary battery series body 2 is set lower than that of the fuel cell 1. Accordingly, in a state in which the fuel cell 1 and the secondary battery series body 2 are connected by the connection switch 4, at the time of low load, the secondary battery series body 2 is charged by a difference between the voltage of the fuel cell 1 and the open circuit voltage of the secondary battery series body 2. On the other hand, at the time of high load, the voltage of the fuel cell 1 falls below that of the secondary battery series body 2, causing the secondary battery series body 2 to discharge.

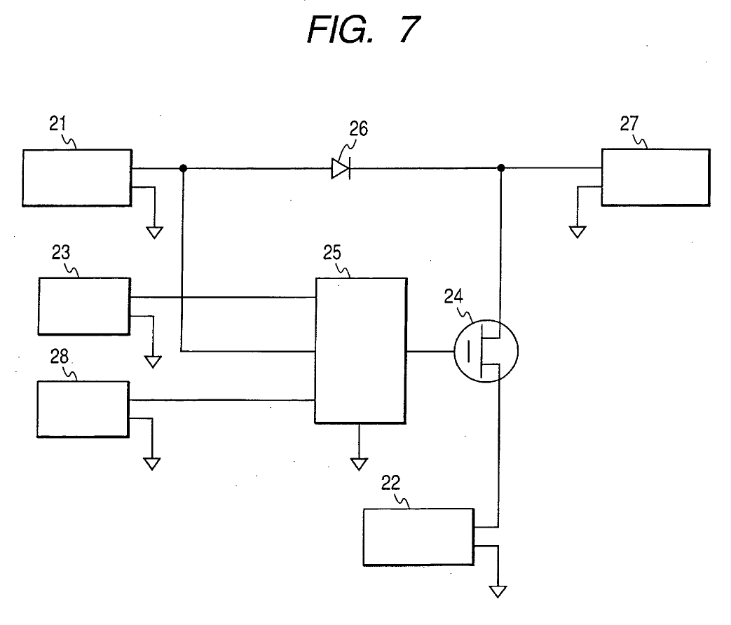

FIG. 7 shows a block diagram of a control circuit used in the present embodiment.

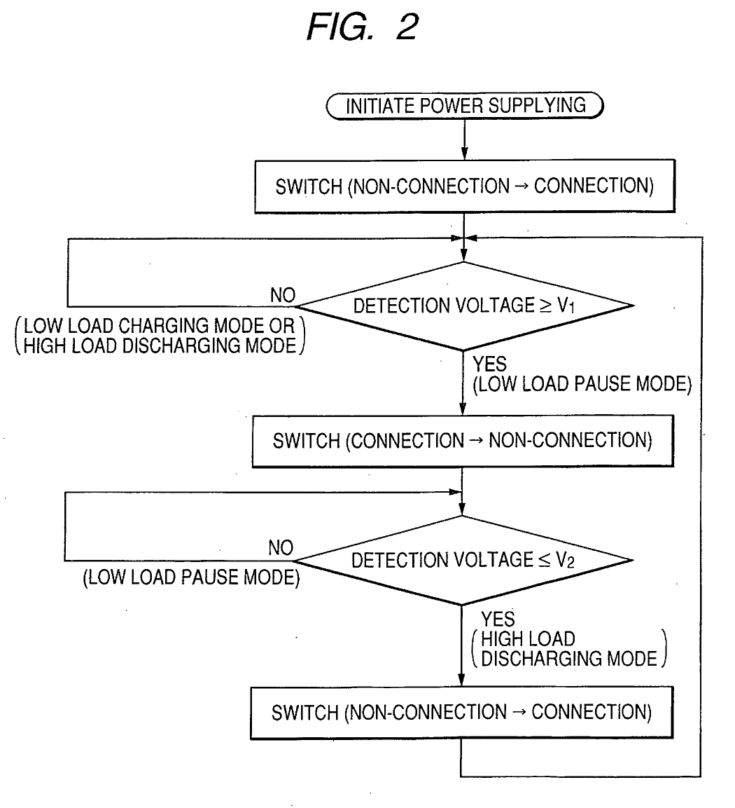

There is included a transistor 24 being a switch for performing switching between the state of connecting in parallel the fuel cell 21 and the secondary battery series body 22 and the state of non-connection. As an illustrative example of the voltage detector and controller for detecting a voltage of the fuel cell 21 and for controlling the switch 24 by the detection voltage, there are used a reference voltage generator 23 for generating a reference voltage of set value V₁, a reference voltage generator 28 for generating a reference voltage of set value V₂, and a logic circuit 25 including a voltage comparator and configured to implement the flow of FIG. 2. In the present embodiment, as a driving power source of the reference voltage generators 23 and 28 and the logic circuit 25, there is used a separate power source not shown, but the fuel cell or secondary battery may be used as the power source. Also, on a circuit connecting the fuel cell 21 and the secondary battery series body 22, there is arranged a diode 26 preventing an inverse current to the fuel cell 21. Reference numeral 27 denotes an external load.

FIG. 2 shows a control flow in the present embodiment. The control flow includes low load charging mode in which the secondary battery series body 2 is charged by the fuel cell 1, high load discharging mode in which the secondary battery series body 2 discharges, and low load pause mode in which charging of the secondary battery series body 2 is stopped.

At the time of initiating power supplying to an external load, the connection switch 4 connects in parallel the fuel cell 1 and the secondary battery series body 2, and according to the magnitude of load, switching between the low load charging mode and the high load discharging mode is spontaneously performed.

At this time, when charging quantity of the secondary battery series body 2 increases and the detection voltage reaches set value V₁, the connection switch 4 cuts off the connection and the flow proceeds to the low load pause mode.

Also, in the low load pause mode, when the detection voltage is equal to or less than set value V₂ which is lower than set value V₁, the connection switch 4 connects in parallel the fuel cell 1 and the secondary battery series body 2 again and a change to the high load discharging mode is made.

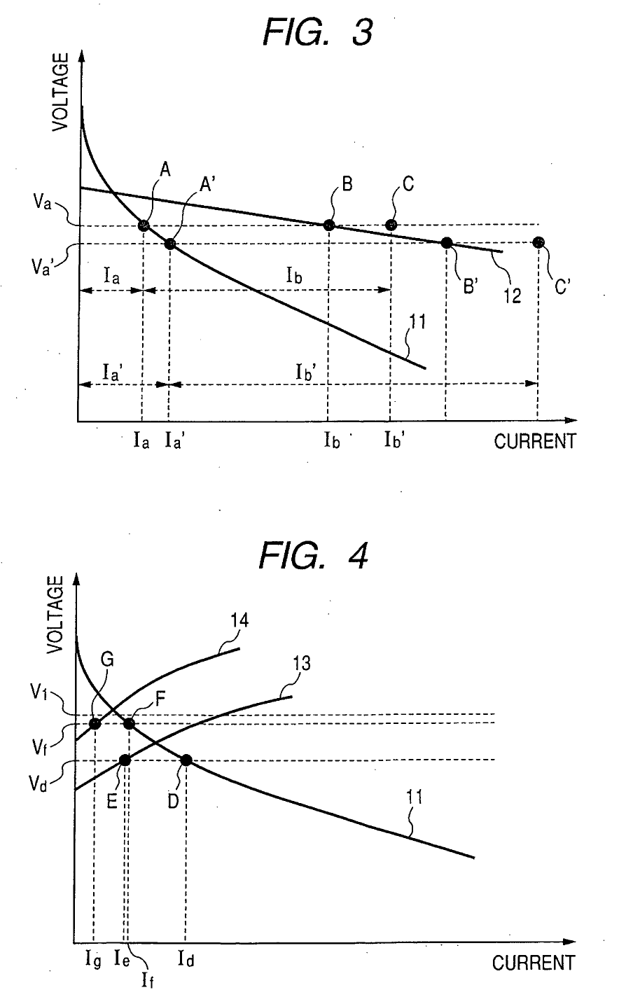

The high load discharging mode in the present embodiment will be described in detail with reference to FIG. 3. In FIG. 3, curve 11 indicates a current-voltage curve of the fuel cell 1; curve 12 indicates a current-voltage curve of the secondary battery series body 2. When power generation of the fuel cell 1 is performed at point A on curve 11, the secondary battery series body 2 discharges at a point on curve 12 having voltage Va identical to that of point A, i.e., at point B. Consequently, the point indicating the output of the hybrid type fuel cell system is point C having a current obtained by adding current Iₐ at point A and current I_{b} at point B, and voltage Vₐ.

Also, in FIG. 3, points A′ to C′ denote points indicating power generation of the fuel cell 1, discharging of the secondary battery series body 2, and the output of the hybrid type fuel cell system when the voltage of the fuel cell 1 lowers from Vₐ to Vₐ′ . Points A′ to C′ correspond to points A to C described above, respectively. In this manner, since the points at which power generation of the fuel cell 1 and discharging of the secondary battery series body 2 are performed move on the respective current-voltage curves, the output of the hybrid type fuel cell system can be varied and an appropriate output dependent on the driving state of an external load can be fed.

Also, when the load lowers and the voltage of the fuel cell 1 rises to a value higher than the open circuit voltage of the secondary battery series body 2, the direction of current flowing in the secondary battery series body 2 is inverted and a change to the low load charging mode can be spontaneously made.

The low load charging mode in the present embodiment will be described in detail with reference to FIG. 4. In FIG. 4, both curves 13 and 14 indicate charging curves of the secondary battery series body 2; curve 13 corresponds to when charging quantity is small and curve 14 corresponds to when charging quantity is large. In FIG. 4, point D denotes a point indicating power generation of the fuel cell 1. At this time, the secondary battery series body 2 is charged at a point on curve 13 having voltage V_{d} identical to that of point D, i.e., at point E. Similarly, in FIG. 4, point F denotes a point indicating power generation of the fuel cell 1. At this time, the secondary battery series body 2 is charged at a point on curve 14 having voltage V_{f} identical to that of point F, i.e., at point G. As described above, curves 13 and 14 are charging curves corresponding to different charging quantities of the secondary battery series body 2. Therefore, as charging goes on, the point indicating charging of the secondary battery series body 2 moves sequentially from point E to point G and charging current of the secondary battery series body decreases sequentially from Iₑ to I_{g} in FIG. 4.

When charging quantity further increases, the point indicating charging of the secondary battery series body 2 passes through from point E to point G and moves toward a direction of low current and high voltage. Finally, when charging voltage reaches set value V₁, the connection switch 4 cuts off the connection between the fuel cell 1 and the secondary battery series body 2 to complete the charging.

At this time, if set value V₁ is set lower than the open circuit voltage when the secondary battery series body 2 is fully charged, the secondary battery series body 2 can be prevented from being overcharged and deteriorated. Further, since lowering of charging efficiency caused by overcharging is suppressed, power generated by the fuel cell 1 can be efficiently used.

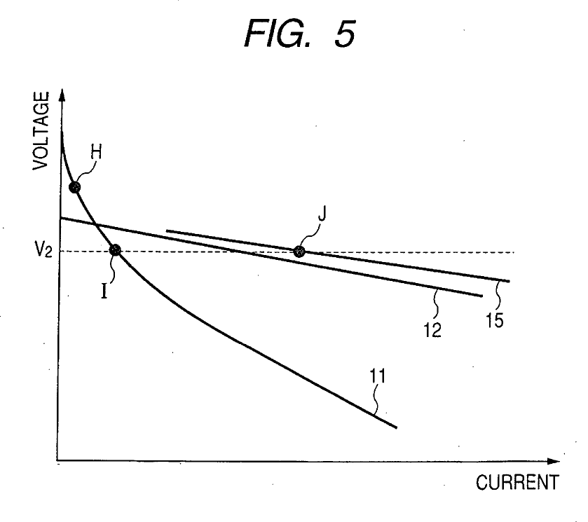

The change from the low load pause mode to the high load discharging mode in the present embodiment will be described with reference to FIG. 5. In FIG. 5, point H denotes a point indicating power generation of the fuel cell 1 in the low load pause mode, i.e., a point indicating an output of the hybrid type fuel cell system. Curve 15 indicates a current-voltage curve of the hybrid type fuel cell system in the high load discharging mode.

When the load increases in the low load pause mode, the point indicating power generation of the fuel cell 1 moves from point H to point I on curve 11. Finally, when point I is reached, i.e., when the voltage of the fuel cell 1 lowers to set value V₂, the connection switch 4 connects in parallel the fuel cell 1 and the secondary battery series body 2. Since set value V₂ is set to a value lower than set value V₁, i.e., to a value lower than the voltage of the secondary battery series body 2 when charging is stopped, the secondary battery series body 2 discharges and the point indicating an output of the hybrid type fuel cell system changes to a point on curve 15 having voltage V₂, i.e., point J. In this manner, when the voltage of the fuel cell 1 lowers to set value V₂, the fuel cell 1 and the secondary battery series body 2 are connected in parallel to each other. Consequently, a change to the high load discharging mode can be made.

### Embodiment 2

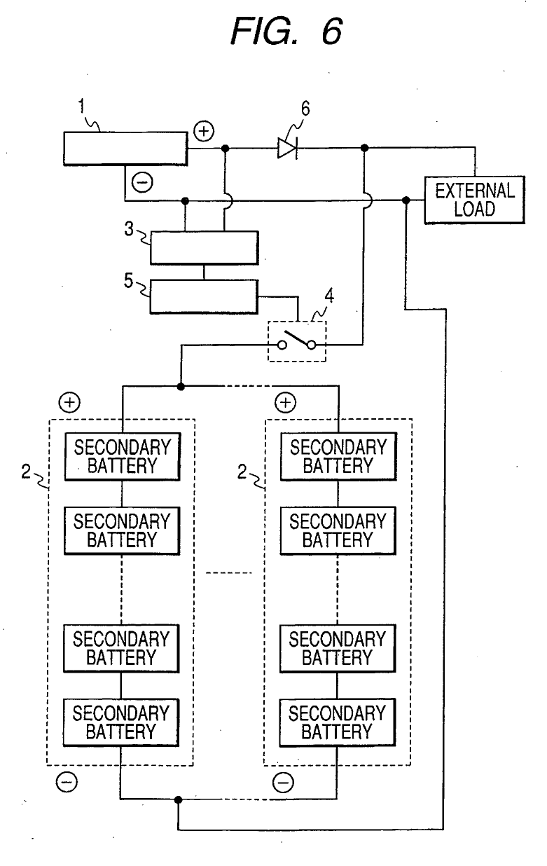

Another embodiment of the present invention will be described below with reference to FIG. 6. A hybrid type fuel cell system according to the present embodiment includes: a fuel cell 1; a voltage detector 3 for detecting a voltage of the fuel cell 1; a switch 4 performing switching between the state of connecting in parallel the fuel cell 1 and the secondary battery series body 2 and the state of non-connection; and a controller 5 for controlling the switch 4 according to a detection voltage. The open circuit voltage of the secondary battery series body 2 is set lower than the open circuit voltage of the fuel cell 1. Also, on a circuit connecting the fuel cell 1 and the secondary battery series body 2, there is arranged a diode 6 preventing an inverse current to the fuel cell 1.

In the present embodiment, a plurality of secondary battery series bodies 2 are connected in parallel to the fuel cell 1. Therefore, as long as the connection switch 4 connects the fuel cell 1 and the secondary battery series bodies 2, the charging state of the plurality of secondary battery series bodies 2 can be managed by detecting the voltage of the fuel cell 1. Consequently, in the present embodiment, the operation can be performed according to a control flow identical to that of embodiment 1.

Also, at the time of high load, current can be extracted from each of the secondary battery series bodies 2, and the range of output current value of the hybrid type fuel cell system can thus be widened. Also, the variation in voltage of the hybrid type fuel cell system associated with a variation in load can be reduced. Also, in embodiment 1 and embodiment 2, when there is used a secondary battery series body such that the open circuit voltage when the secondary battery series body 2 is fully charged is lower than the open circuit voltage of the fuel cell 1, the secondary battery series body 2 can be sufficiently charged by the fuel cell 1 in the low load charging mode. Consequently, the hybrid type fuel cell system making good use of the capacity of the secondary battery series body 2 can be constructed.

Also, even when a secondary battery series body is used such that the open circuit voltage when the secondary battery series body 2 is fully charged is higher than the open circuit voltage of the fuel cell 1, it is possible to use this if the secondary battery series body 2 has a state in which the open circuit voltage thereof is lower than the open circuit voltage of the fuel cell 1 in the case of lower charging quantity. In this case, also, the above described effect of the present invention can be achieved.

Also, in embodiment 1 and embodiment 2, there is used the secondary battery series body 2 constituted of secondary batteries connected in series. However, it is also possible to use a secondary battery not connected in series instead of the secondary battery series body 2. In this case, the open circuit voltage of the secondary battery and the open circuit voltage of the fuel cell 1 need to satisfy the above described relationship.

The hybrid type fuel cell system according to the present invention can suppress power loss and secondary battery degradation caused by overcharging and at the same time, by virtue of having a simple configuration, can be used in an electric device such as a digital still camera.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-252452, filed Aug. 31, 2005, which is hereby incorporated by reference herein in its entirety.

What is claimed is:

1. A fuel cell system comprising:
a fuel cell;
a secondary battery having an open circuit voltage lower than an open circuit voltage of the fuel cell;
a voltage detector for detecting a voltage of the fuel cell;
a switch for connecting the secondary battery in parallel to the fuel cell; and
a controller for controlling the switch according to a detection voltage detected by the voltage detector.

2. The fuel cell system according to claim 1, wherein the switch is controlled such that:
at the time of initiating power supplying to an external load, a change is made to a state in which the fuel cell and the secondary battery are connected in parallel to each other;
when the detection voltage is equal to or more than a first set value, a change is made to a state in which the fuel cell and the secondary battery are not connected in parallel to each other; and
when the detection voltage is equal to or less than a second set value lower than the first set value, a change is made to a state in which the fuel cell and the secondary battery are connected in parallel to each other.

3. A fuel cell system comprising:
a fuel cell;
a secondary battery connection terminal for connecting in parallel a secondary battery having an open circuit voltage lower than an open circuit voltage of the fuel cell;
a voltage detector for detecting a voltage of the fuel cell;
a switch for connecting the secondary battery connection terminal in parallel to the fuel cell; and
a controller for controlling the switch according to a detection voltage detected by the voltage detector.

4. The fuel cell system according to claim 3, wherein the switch is controlled such that:
at the time of initiating power supplying to an external load, a change is made to a state in which the fuel cell and the secondary battery connection terminal are connected in parallel to each other;
when the detection voltage is equal to or more than a first set value, a change is made to a state in which the fuel cell and the secondary battery connection terminal are not connected in parallel to each other; and
when the detection voltage is equal to or less than a second set value lower than the first set value, a change is made to a state in which the fuel cell and the secondary battery connection terminal are connected in parallel to each other.
